(19) United States
(12) Patent Application Publication
(10) Pub. No.: US 2020/0096635 A1
(43) Pub. Date: Mar. 26, 2020

(54) OBJECT DETECTION DEVICE AND METHOD FOR MONITORING A LIGHT PROJECTION SURFACE FOR A PENETRATION BY AN OBJECT

(71) Applicant: Robert Bosch GmbH, Stuttgart (DE)

(72) Inventors: Frank Fischer, Gomaringen (DE); Gael Pilard, Wankheim (DE)

(21) Appl. No.: 16/495,489

(22) PCT Filed: Jan. 23, 2018
(86) PCT No.: PCT/EP2018/051510

§ 371 Date: Sep. 19, 2019

(30) Foreign Application Priority Data
Mar. 21, 2017 (DE) 10 2017 204 668.6

(51) Int. Cl. G01S 17/04; G02B 27/10; G08B 21/18; G08B 5/36; G08B 21/02; G01S 7/481

(52) U.S. Cl. CPC G01S 17/04; G02B 27/1086; G08B 21/182; G01S 7/4817; G08B 21/02; G01S 7/4815; G08B 5/36

(57) ABSTRACT

An object detection device is described for a light projection surface having at least one light source, which is developed to emit a light beam in such a way that a beam pattern of light beams emitted by a plurality of light sources or of partial beams of the at least one light beam emitted by the at least one light source is able to be radiated at least onto a portion of the light projection surface and/or at least into a partial environment of the light projection surface; and having a detection device which is developed to establish a possible penetration of the radiated beam pattern by an object, based on a reflection of the radiated beam pattern, and to output an object warning signal as the case may be. Also described is a method for monitoring a light projection surface for a penetration by an object by radiating a beam pattern at least onto a portion of the light projection surface, and/or at least into a partial environment of the light projection surface; and ascertaining whether the radiated beam pattern has been penetrated by an object based on a reflection of the radiated beam pattern.

### FIELD OF THE INVENTION

The present invention relates to an object detection device for a light projection surface. In the same way, the present invention relates to a device which is configured to project at least one scanning beam onto the light projection surface. In addition, the present invention relates to a method for monitoring a light projection surface for a penetration by an object.

### BACKGROUND INFORMATION

Projectors such as the image-generating device for a head-up display described in DE 10 2014 217 180 A1, for example, are known from the related art. The image-generating device is designed to project an image onto the light projection surface by scanning a light projection surface. A corresponding technology is also used by optical scanning devices, which detect at least one characteristic of the light projection surface by scanning a light projection surface with the aid of at least one scanning beam.

### SUMMARY

The present invention provides an object detection device for a light projection surface; a device which is developed to project at least one scanning beam onto the light projection surface; and a method for monitoring a light projection surface for the penetration by an object.

The present invention provides possibilities for a rapid and reliable detection of an object that has penetrated a light projection surface, such as a light projection surface of a projector/image projector or an optical scanning device, in particular. If a person penetrates the light projection surface or at least penetrates a scanning beam/laser beam projected onto the light projection surface, a timely reaction is possible so that there is no risk of injury to the eye of the involved person. As a result, the present invention contributes to an improved safety standard when using of projectors/image projectors or scanning devices.

The object detection device is preferably developed to interact with a device which projects at least one scanning beam onto the light projection surface, at least in that the device is able to be controlled with the aid of the object warning signal to the effect that a light intensity of the at least one scanning beam projected onto the light projection surface is reduced or the projection of the at least one scanning beam onto the light projection surface is at least briefly interrupted. This improves the safety standard of the respective device.

For example, the object detection device may have a beam splitter device, by which the at least one light beam emitted from the at least one light source is able to be split up into a plurality of partial beams so that the beam pattern of partial beams is able to be emitted at least onto the portion of the light projection surface and/or into at least the partial environment of the light projection surface. This is easily realizable from a construction standpoint.

In one advantageous embodiment of the object detection device, the beam splitter device includes at least one diffractive optical element and/or at least one holographic element. The at least one diffractive optical element may be a prism and/or an optical grating, for instance. As a result, cost-effective optical elements that also require relatively little space are able to be used for realizing the beam splitter device.

In one further advantageous embodiment, the object detection device includes a plurality of light sources, and the beam splitter device is developed to split each of the light beams emitted by the light sources into a line of partial beams in such a way that each of the lines of partial beams impinges upon at least one allocated projection surface strip of the light projection surface. Such an object detection device has a relatively simple and cost-effective design.

In this case, the object detection device preferably also includes a control unit, which is developed to activate each of the light sources independently of the other light sources so that the respective light source is activated only shortly before and/or while a scanning beam scanning the light projection surface in a line-type manner impinges upon the projection surface strip allocated to the respective light source. This embodiment of the object detection device uses relatively little energy.

The afore-described advantages may also be achieved by a device that is developed to project at least one scanning beam onto the light projection surface with the aid of such an object detection device. For example, the device may be a projector, an image projector or an optical scanning device. The device is able to be further developed according to the described embodiments of the object detection device.

In addition, the execution of a corresponding method for monitoring a light projection surface for a penetration by an object also provides the afore-described advantages. The method for monitoring a light projection surface for a penetration by an object may likewise be further developed according to the afore-described specific embodiments of the object detection device.

### BRIEF DESCRIPTION OF THE DRAWINGS

FIGS. 1a and 1b show a schematic illustration of a first specific embodiment of the object detection device and a beam pattern that it is able to generate.

FIG. 2 shows a beam pattern able to be generated by a second specific embodiment of the object detection device.

FIG. 3 shows a beam pattern able to be generated by a third specific embodiment of the object detection device.

FIG. 4 shows a beam pattern able to be generated by a fourth specific embodiment of the object detection device.

FIG. 5 shows a beam pattern able to be generated by a fifth specific embodiment of the object detection device.

FIG. 6 shows a beam pattern able to be generated by a sixth specific embodiment of the object detection device.

FIG. 7 shows a beam pattern able to be generated by a seventh specific embodiment of the object detection device.

FIG. 8 shows a flow diagram to describe a specific embodiment of the method for monitoring a light projection surface for a penetration by an object.

### DETAILED DESCRIPTION

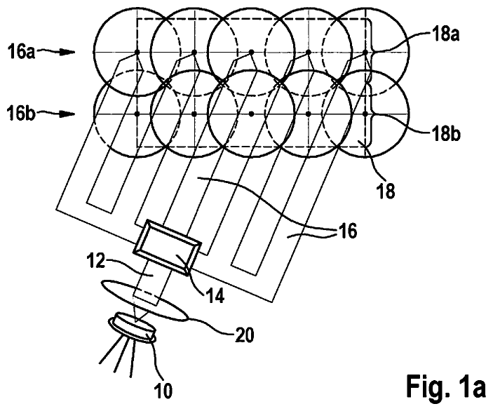

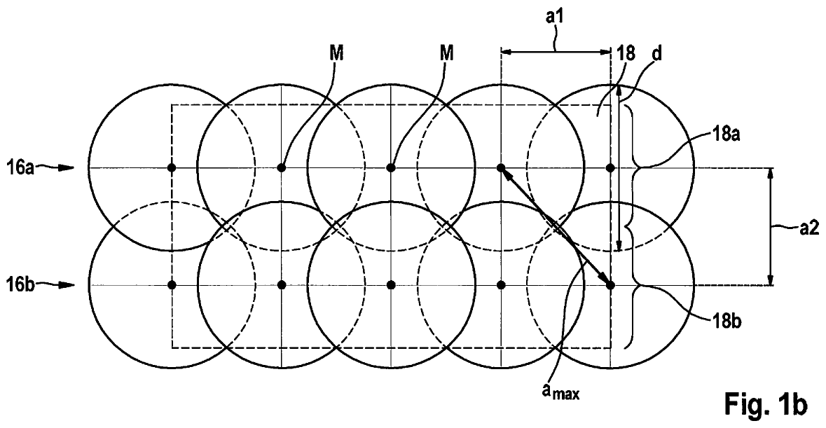

FIGS. 1a and 1b show a schematic illustration of a first specific embodiment of the object detection device and a beam pattern that it is able to generate.

The object detection device schematically shown in FIG. 1a includes at least one light source 10, which is developed to emit a light beam 12 in each case. In addition, the object detection device has a beam splitter device 14, by which the at least one light beam 12 emitted by the at least one light source 10 is able to be split into a plurality of partial beams 16 so that a beam pattern of partial beams 16 (of the at least one light beam 12 emitted by the at least one light source 10) is able to be radiated/is radiated at least onto a portion of a light projection surface 18 and/or at least into a partial environment of light projection surface 18. In the specific embodiment of Figure la, a collimator 20 is additionally situated between the at least one light source 10 and beam splitter device 14 by way of example. However, this should simply be interpreted as an example. Still further optical elements may of course be situated in a beam path of the at least one light beam 12 emitted by the at least one light source 10. Additional optical elements may be used for imaging the beam pattern of partial beams 16, which are not discussed here, however.

The object detection device also has a detection device (not shown), which is developed to establish a possible penetration of an object (not shown) into the radiated beam pattern based on a reflection of the radiated beam pattern. If the detection device establishes/determines (e.g., due to a sudden change in the reflection of the radiated beam pattern) that an object apparently has penetrated the radiated beam pattern, then the detection device outputs a corresponding object warning signal.

The object warning signal is preferably output to a control of a device (not sketched), which projects at least one scanning beam onto light projection surface 18. The device that projects the at least one scanning beam onto light projection surface 18 may be a projector/image projector or an optical scanning device, for instance. As a result, the control may be informed in a timely manner that it is advantageous to reduce a light intensity of the at least one scanning beam projected onto light projection surface 18 or (at least briefly) to interrupt the projection of the at least one scanning beam onto light projection surface 18. If a person (as the object) penetrates light projection surface 18 (or the area between the device emitting the at least one scanning beam and light projection surface 18), there is no need to worry about an eye injury of the person caused by the at least one scanning beam. The object detection device thus contributes to an improved safety standard of the respective device projecting the at least one scanning beam onto light projection surface 18. The object detection device described here in particular allows for a risk-free use of a projector/image projector and/or an optical scanning device in a mobile device such as a mobile phone.

Devices that emit scanning beams, e.g., projectors/image projectors or optical scanning devices, are frequently developed to scan their allocated light projection surface 18 with the aid of the at least one scanning beam in a line-type manner in order to thereby project an image onto light projection surface 18 or to detect at least one property of light projection surface 18. This usually entails the risk that an eye of a person entering light projection surface 18 (or the area between the device emitting the at least one scanning beam and light projection surface 18) is also “scanned” by the at least one scanning beam. However, this conventional risk is reliably avoidable by the described object detection device. More specifically, by generating the beam pattern of partial beams 18, a detection time/identification time at which the movement of the object/the person into light projection surface 18 (or the area between the device emitting the at least one scanning beam and light projection surface 18) is detectable is significantly shortened in comparison with the scanning of light projection surface 18. An earlier reaction is consequently possible so that the scanning of an eye by the at least one scanning beam emitted at the full light intensity is prevented.

The interaction between the object detection device and the device projecting the at least one scanning beam onto light projection surface 18 also allows for a relatively high light intensity of the at least one scanning beam projected onto the light projection surface 18, without the need to worry about an injury risk as a result of light projection surface 18 (or the area between the device emitting the at least one scanning beam and light projection surface 18) having been penetrated by an unnoticed person. With the aid of the light intensity of the at least one scanning beam projected onto light projection surface 18, which is easily increasable by the interaction between the object detection device and the respective device, an operativeness of the respective device is able to be increased as well. Thus, the object detection device considerably contributes to an increasing acceptance of such devices, e.g., projectors/image projectors or optical scanning devices.

For example, a laser such as in particular a VCSEL (vertical cavity surface emitting laser) may be used as the at least one light source 10 of the object detection device. A self-interfering laser emitter having integrated photodiodes (as detection device) may also be used as the at least one light source 10. The advantage of the integrated photodiodes is a restriction of their sensitivity to a certain wavelength, so that there is no or hardly any interference with the detection principle from other light sources, such as sun irradiation.

Beam splitter device 14 may include at least one diffractive optical element. Diffractive optical elements are relatively robust with respect to dust or local changes in a surface of the diffractive optical element. In addition, diffractive optical elements have high robustness with respect to vibrations/shocks in their immediate environment. Equipping the object detection device with the at least one diffractive optical element thus makes the object detection device more robust and also facilitates its integration into a device such as a mobile device, in particular.

For example, the at least one diffractive optical element may be a prism and/or an optical grating.

Such diffractive optical elements are not only relatively cost-effective but also allow the at least one light beam 12 to be split/divided into partial beams 16 or into the beam pattern of partial beams 16. It is pointed out, however, that the described development possibility of beam splitter device 14 is meant to be understood as merely one example. Beam splitter device 14 may additionally also have at least one holographic element. Since the realizability of the object detection device is not restricted to a specific development of its detection device, the detection device will not be discussed here in greater detail.

The object detection device from FIG. 1a includes a plurality of light sources 10, and beam splitter device 14 is developed to split each of light beams 12 emitted by light sources 10 into a (level/horizontally aligned) line 16a and 16b of partial beams 16. Each one of lines 16a and 16b of partial beams 16 impinges upon at least one associated (level/horizontally aligned) projection surface strip 18a and 18b of light projection surface 18. (The respective projection surface strip 18a or 18b is thus at least partially/completely covered by the “detection ranges” of allocated line 16a and 16b of partial beams 16 described below). In particular, a total number of projection surface strips 18a and 18b is able to completely cover light projection surface 18. Alternatively, the object detection device may also be developed to split each one of light beams 12 emitted by light sources 10 into a respective (perpendicular/vertically aligned) column of partial beams 16. In this case, each of the columns of partial beams may impinge upon at least one allocated (perpendicular/vertically aligned) projection surface strip of light projection surface 18, and a total number of the (perpendicular/vertically aligned) projection surface strips preferably completely covers light projection surface 18. (In this case as well, the respective projection surface strip may be at least partially/completely covered by the “detection ranges” of the allocated perpendicular/vertically aligned line of partial beams 16).

FIG. 1b shows the beam pattern radiated onto light projection surface 18 with the aid of the object detection device. A “detection range” (vertical measuring range) having a detection diameter d of 100 mm may be allocated to each partial beam 16. (For instance, a beam diameter (not illustrated) of partial beams 16 may lie in the millimeter range such as between 0.5 mm and 2 mm). The “detection range” indicates a range in which an object having an extension of approximately 100 mm (such as the head of a child) is unable to penetrate without being detected by respective partial beam 16.

A first level/horizontal distance al between center points M of adjacent light points/light spots of the same line 16a or 16b of partial beams 16 is smaller than 70 mm in the horizontal direction. A second perpendicular/vertical distance as between center points M of adjacent light points/light spots of adjacently situated lines 16a and 16b of partial beams 16 is also less than 70 mm. This ensures that a maximum distance aₘₐₓ between center point M of adjacent light points/light spots is likewise smaller than 100 mm. As a result, no area having a diameter of at least 100 mm of light projection surface 18 remains uncovered/unmonitored. The requirements of the IEC 60825-1 Ed 3 standard are thus reliably satisfied.

In the beam pattern of FIG. 1b, center points M of the light points/light spots of partial beams 16 are placed on light projection surface 18 in such a way that outer center points M of light points/light spots of the same line 16a and 16b of partial beams 16 lie on the perpendicular/vertically aligned edges of light projection surface 18. A side environment of light projection surface 18 is therefore also able to be monitored for a possible penetration by an object or person. This is advantageous because persons normally approach light projection surface 18 from the side. Outer center points M of the light points/light spots of partial beams 16 in the vertical direction have a distance from the adjacent edge of light projection surface 18 that is greater than one fourth of detection diameter d of the “detection ranges” (virtual measuring ranges).

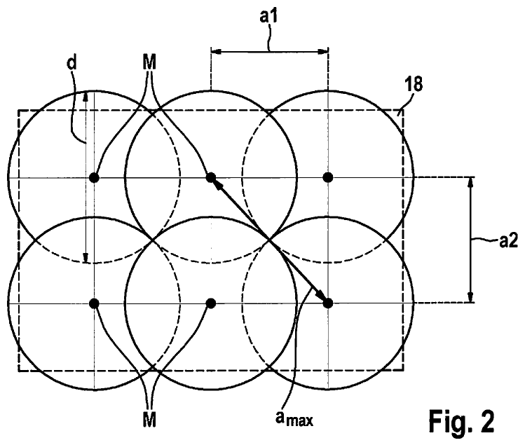

FIG. 2 shows a beam pattern that is able to be generated using a second specific embodiment of the object detection device.

In the beam pattern schematically reproduced in FIG. 2 as well, first level/horizontal distance a₁ between center points M of adjacent light points/light spots of the same line 16a or 16b of partial beams 16 and second perpendicular/vertical distance a₂ between center points M of adjacent light points/light spots of adjacently positioned lines 16a and 16b of partial beams 16 are also smaller than 70 mm in each case. Accordingly, maximum distance aₘₐₓ between center point M of adjacent light points/light spots is smaller than 100 mm. As a result, no area having a diameter of at least 100 mm of light projection surface 18 remains uncovered/unmonitored, and the requirements of the IEC 60825-1 Ed 3 standard are satisfied.

However, in the beam pattern of FIG. 2, outer center points M of light points/light spots of the same line 16a and 16b have a distance from the adjacent edge of light projection surface 18 that is greater than one fourth of detection diameter d of the detection ranges (virtual measuring ranges). Even relatively few partial beams 14 are therefore suitable for the complete coverage of light projection surface 18.

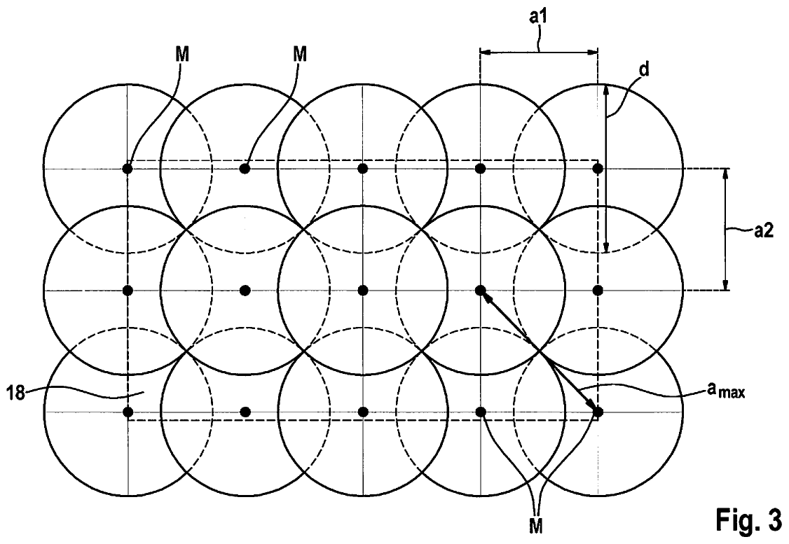

FIG. 3 shows a beam pattern that is able to be generated by a third specific embodiment of the object detection device.

The beam pattern schematically illustrated in FIG. 3 has the first level/horizontal distance a₁ between center points M of adjacent light points/light spots of the same line 16a or 16b of partial beams 16 that is smaller than 70 mm; second perpendicular/vertical distance a₂ between center points M of adjacent light points/light spots of adjacently situated lines 16a and 16b of partial beams 16 that is smaller than 70 mm; and maximum distance aₘₐₓ between center point M of adjacent light points/light spots that is smaller than 100 mm. No surface having a diameter of at least 100 mm of light projection surface 18 remains uncovered/unmonitored, which satisfies the requirements of the IEC 60825-1 Ed 3 standard.

In addition, outer center points M of light points/light spots of the same line 16a and 16b of partial beams 16 lie on the perpendicularly/vertically aligned edges of light projection surface 18, and the outer center points M of the light points/light spots of partial beams 16 in the vertical direction lie on the level/horizontally aligned edges of light projection surface 18. As a result, it is possible to check not only a side environment of light projection surface 18 but also a lower environment and an upper environment of light projection surface 18 for the possible penetration by an object/person. In particular, the approach of the head of a person toward light projection surface 18 is detectable in a timelier manner.

FIG. 4 shows a beam pattern that is able to be generated by a fourth specific embodiment of the object detection device.

The beam pattern schematically illustrated in FIG. 4 also has first level/horizontal distance a₁ between center points M of adjacent light points/light spots of the same line 16a or 16b of partial beams 16 of less than 70 mm; second perpendicular/vertical distance a₂ between center points M of adjacent light points/light spots of adjacently situated lines 16a and 16b of partial beams 16 of less than 70 mm; and maximum distance aₘₐₓ between center point M of adjacent light points/light spots of less than 100 mm. No surface having a diameter of at least 100 mm of light projection surface 18 remains uncovered/unmonitored (i.e. the IEC 60825-1 Ed 3 standard is satisfied).

In the beam pattern of FIG. 4, outer partial beams 16 (or light points/light spots) form a “light frame” that surrounds light projection surface 18. As a result, it is possible to react even while an object/person is approaching light projection surface 18, in particular while the head of a person is approaching, and an impingement of the at least one scanning beam projected onto light projection surface 18 on the object/person does not seem likely or is barely likely. In addition, in the beam pattern of FIG. 4, it is possible (at least in the interim) to dispense with the emission of the inner partial beams surrounded by the “light frame”/outer partial beams 16.

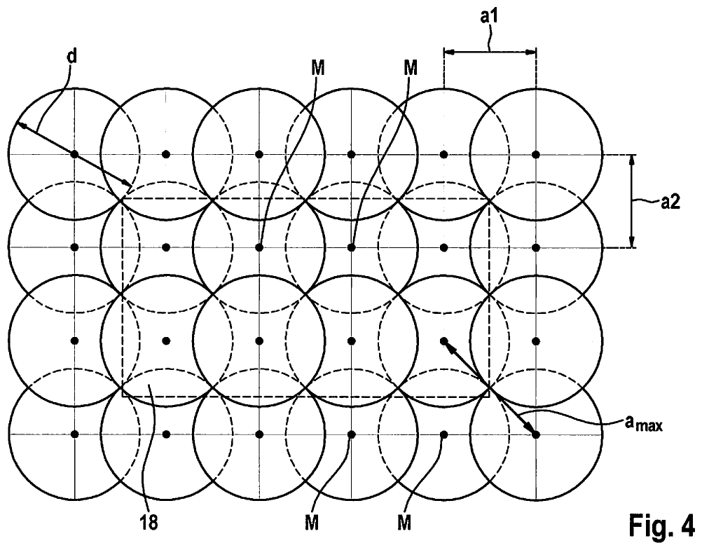

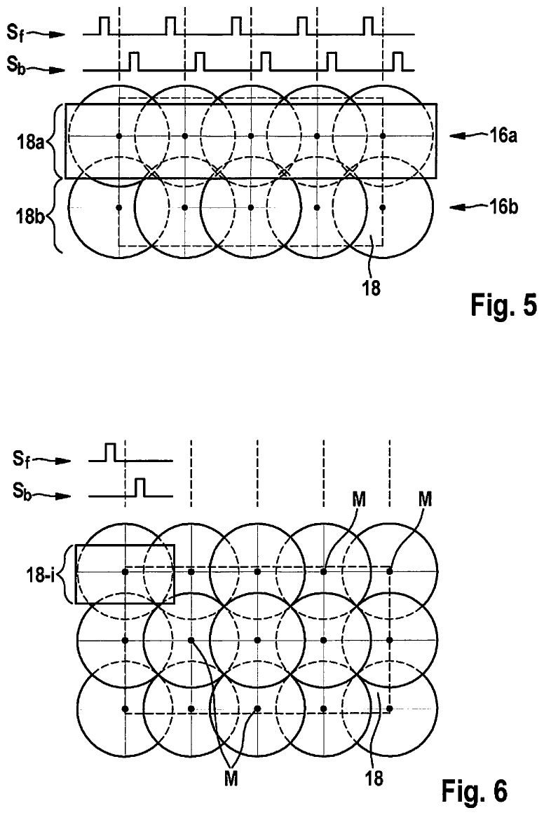

FIG. 5 shows a beam pattern that is able to be generated using a fifth specific embodiment of the object detection device.

The object detection device schematically reproduced by FIG. 5 likewise satisfies the IEC 60825-1 Ed 3 standard. The object detection device has a plurality of light sources 10 and a beam splitter device 14 by which each one of light beams 12 emitted by light sources 10 is able to be split into a respective (level/horizontally aligned) line 16a and 16b so that each one of lines 16a and 16b of partial beams (16) impinges at least upon the (level/horizontally aligned) allocated projection surface strip 18a or 18b of light projection surface 18. The object detection device interacts with a device (not shown) which scans light projection surface 18 by a (single) scanning beam in a line-type manner, the scanning beam requiring 10 μs per line of light projection surface 18 and thereby scanning entire light projection surface 18 once within 10 ms.

In addition, the object detection device has a control unit (not shown), which is developed to activate each light source 10 independently of the other light sources 10 in such a way that the respective light source 10 is activated only shortly before and/or while the scanning beam that is scanning light projection surface 18 in a line-type manner impinges upon projection surface strip 18a or 18b allocated to respective light source 10. This makes it possible to save energy.

FIG. 5 exemplarily also shows signals S_{f} (trigger forth) and S_{b} (trigger back) by which light source 10 allocated to projection surface strip 18a is controlled.

FIG. 6 shows a beam pattern able to be generated by a sixth specific embodiment of the object detection device.

The object detection device schematically illustrated by FIG. 6 has a system that is made up of a plurality of light sources 10 (e.g., a system of a plurality of lasers), each emitting a separate light beam 12 so that the beam pattern of light beams 12 emitted by the plurality of light sources is able to be radiated/is radiated at least to the portion of light projection surface 18 and/or at least into the partial environment of light projection surface 18. A micro-optical lens system, for example, may be used to image the beam pattern.

In the example of FIG. 6, a separate projection surface portion 18-i is able to be allocated to each light source 10. Only a single projection surface portion 18-i has been sketched in FIG. 6 by way of example. In this way, each light source 10 may be activated (independently of the other light sources 10) only shortly before and/or while the scanning beam that scans light projection surface 18 in a line-type manner impinges upon projection surface portion 18-i allocated to respective light source 10. The use of this procedure likewise makes it possible to save energy. FIG. 6 exemplarily also shows signals S_{f} (trigger forth) and S_{b} (trigger back) by which the (single) light source 10 allocated to projection surface portion 18-i is controlled.

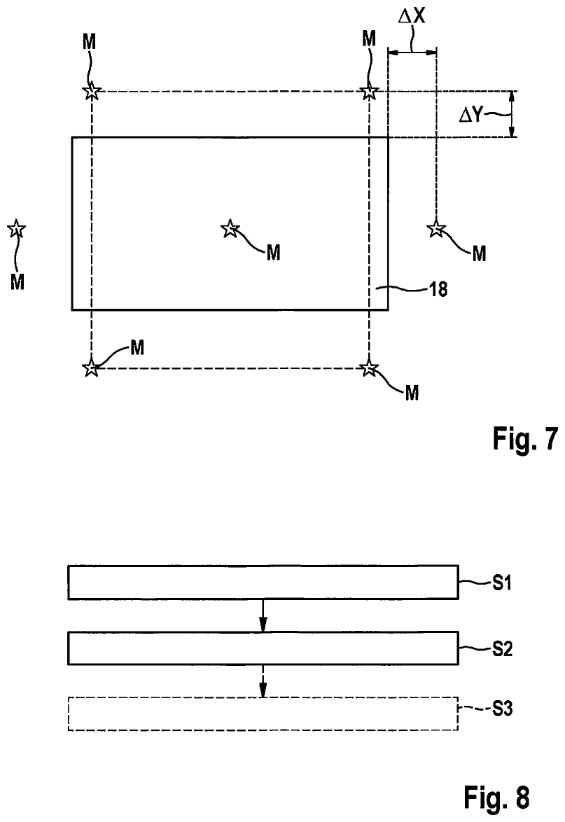

FIG. 7 shows a beam pattern that is able to be generated by a seventh specific embodiment of the object detection device.

The object detection device schematically illustrated in FIG. 7 is well suited for establishing that an object has penetrated a light projection surface 18 in the near range. Center points M of light points/light spots of the beam pattern radiated in the direction of light projection surface 18 are selectively also directed toward an environment of light projection surface 18. Only center points M of the central light point/light spot lies in light projection surface 18. Center points M of the lateral light points/light spots lie on a common (level/horizontal) line with center point M of central light point/light spot, but outside light projection surface 18 at a distance Δx from the adjacent (level/horizontal) edge of light projection surface 18. Center points M of the two upper light points/light spots and center points M of the two lower light points/light spots also lie outside light projection surface 18 at a distance Δy from the adjacent (perpendicular/vertical) edge of light projection surface 18. Distances Δx and Δy are selected in such a way that an object penetrating the respective light point/light spot is detected and the scanning beam that is scanning light projection surface 18 is reduced in its light intensity or is (at least briefly) interrupted before the detected object penetrates light projection surface 18.

All of the afore-described beam patterns form a pattern of fixed light points/light spots on light projection surface 18 in order to detect a penetrating object on the basis of the distance measurement. In contrast to a conventional distance measurement with the aid of a light beam scanning light projection surface 18, a stronger signal is able to be received from the detection device when using the pattern of fixed light points/light spots on light projection surface 18. In addition, the use of the pattern of fixed light points/light spots on light projection surface 18 makes it possible to achieve greater stability/reliability in the object detection.

FIG. 8 shows a flow diagram to describe a specific embodiment of the method for monitoring a light projection surface for the penetration by an object.

In a method step S1, a beam pattern is radiated at least onto a portion of the light projection surface and/or at least into a partial environment of the light projection surface. For example, at least one light beam emitted by at least one light source is subdivided into a plurality of partial beams so that the beam pattern of partial beams of the at least one light beam emitted by the at least one light source is radiated to at least the portion of the light projection surface and/or into at least the partial environment of the light projection surface. However, it is also possible to radiate a beam pattern of light beams emitted by a plurality of light sources at least onto the portion of the light projection surface and/or into at least the partial environment of the light projection surface. Examples of beam patterns able to be generated in this manner have already been described earlier in the text.

In a further method step S2, it is ascertained based on a reflection of the radiated beam pattern whether the radiated beam pattern has been penetrated by an object.

If it is detected that the radiated beam pattern has been penetrated by an object, then an additional (optional) method step S3 is preferably executed, in which a light intensity of at least one scanning beam projected onto the light projection surface is reduced or the projection of the at least one scanning beam onto the light projection surface is at least briefly interrupted. As a result, an execution of the described method also allows for an increase in the light intensity of the at least one scanning beam scanning across the light projection surface without causing a risk of an eye injury of an unnoticed person (as an object). In this way, the described method may also be used for projecting images that are richer in contrast and/or brighter onto light projection surface 18.

In method step S1, each one of the light beams emitted by the plurality of light sources is preferably split into a line of partial beams in such a way that each one of the lines of partial beams impinges upon at least one allocated projection surface strip of the light projection surface. In this case, each of the light sources is able to be activated independently of the other light sources in such a way that the respective light source is activated only shortly before and/or while a scanning beam scanning the light projection surface in a line-type manner impinges upon the projection surface strip allocated to the respective light source.

1-13. (canceled)

14. An object detection device for a light projection surface, comprising:
at least one light source for emitting a light beam in such a way that a beam pattern of light beams emitted by a plurality of light sources or of partial beams of the at least one light beam emitted by the at least one light source is able to be radiated at least one of onto a portion of the light projection surface and into a partial environment of the light projection surface; and
a detection device for establishing a possible penetration of the radiated beam pattern by an object based on a reflection of the radiated beam pattern, and for outputting an object warning signal when the object is detected.

15. The object detection device as recited in claim 14, wherein the object detection device is developed to interact with a device projecting at least one scanning beam onto the light projection surface, at least in that the device is able to be controlled with the aid of the object warning signal to reduce a light intensity of the at least one scanning beam projected onto the light projection surface or to at least briefly interrupt a projection of the at least one scanning beam onto the light projection surface.

16. The object detection device as recited in claim 14, further comprising:
a beam splitter device by which the at least one light beam emitted by the at least one light source is able to be split into a plurality of partial beams such that a beam pattern of partial beams is able to be radiated at least one of onto the portion of the light projection surface and into the partial environment of the light projection surface.

17. The object detection device as recited in claim 16, wherein the beam splitter device includes at least one of at least one diffractive optical element and at least one holographic element.

18. The object detection device as recited in claim 17, wherein the at least one diffractive optical element is one of a prism and an optical grating.

19. The object detection device as recited in claim 16, wherein the object detection device includes a plurality of light sources, and the beam splitter device splits each light beam emitted by the light sources into a line of partial beams in such a way that each one of the lines of partial beams impinges upon at least one allocated projection surface strip of the light projection surface.

20. The object detection device as recited in claim 19, further comprising:
a control unit for activating each light source independently of each other light sources such that a respective light source is activated only at least one of shortly before and while a scanning beam scanning the light projection surface in a line-type manner impinges upon the respective projection surface strip allocated to the respective light source.

21. A device for projecting at least one scanning beam onto a light projection surface, comprising:
an object detection device for the light projection surface, comprising:
at least one light source for emitting a light beam in such a way that a beam pattern of light beams emitted by a plurality of light sources or of partial beams of the at least one light beam emitted by the at least one light source is able to be radiated at least one of onto a portion of the light projection surface and into a partial environment of the light projection surface; and
a detection device for establishing a possible penetration of the radiated beam pattern by an object based on a reflection of the radiated beam pattern, and for outputting an object warning signal when the object is detected.

22. The device as recited in claim 21, wherein the device is one of a projector, an image projector, and an optical scanning device.

23. A method for monitoring a light projection surface for penetration by an object, comprising:
radiating a beam pattern at least one of onto a portion of the light projection surface and into a partial environment of the light projection surface; and
ascertaining whether the radiated beam pattern has been penetrated by an object based on a reflection of the radiated beam pattern.

24. The method as recited in claim 23, further comprising:
splitting up at least one light beam emitted by at least one light source into a plurality of partial beams such that a beam pattern of the partial beams of the at least one light beam emitted by the at least one light source is radiated at least one of onto the portion of the light projection surface and into the partial environment of the light projection surface.

25. The method as recited in claim 24, wherein the at least one light source includes a plurality of light sources, wherein each light beam emitted by the plurality of light sources is split into a line of partial beams, in such a way that each line of the partial beams impinges upon at least one allocated projection surface strip of the light projection surface.

26. The method as recited in claim 25, wherein each one of the light sources is activated independently of each other light sources such that a respective light source is activated only at least one of shortly before and while a scanning beam scanning the light projection surface in a line-type manner impinges upon the projection surface strip allocated to the respective light source.
